(19) United States
(12) Patent Application Publication
(10) Pub. No.: US 2009/0095225 A1
(43) Pub. Date: Apr. 16, 2009

(54) Animal Waste Storage Device

(76) Inventor: Kevin George O'Connell, Salem, MA (US)

Correspondence Address: Daniel N. Smith, 15 Church Street, Salem, MA, 01970, US

(21) Appl. No.: 12/132,633

(22) Filed: Jun. 4, 2008

Related U.S. Application Data
(60) Provisional application No. 60/998,853, filed on Oct. 12, 2007.

(51) Int. Cl. A01K 29/00; A01K 27/00

(52) U.S. Cl. 119/161; 119/795

(57) ABSTRACT

A portable solid waste container designed with a central holding chamber. The device features a storage member with a lid that is contained within the chamber. An accessory holding chamber is externally attached to the central holding chamber and is intended to hold a flashlight. A waste bag holding chamber is also externally attached to the central holding chamber and is intended to hold disposable waste bags. The apparatus may be carried by hand by means of an attached handle, or attached to an animal restraining tool, such as a leash or similar device.

### CROSS REFERENCE TO RELATED APPLICATION

This application claims the benefit of U.S. Provisional Application No. 60/998,853 filed on Oct. 12, 2007, the contents of which are incorporated herein by reference.

### FIELD OF THE INVENTION

The present invention relates generally to animal solid waste storage devices and more specifically to a new and improved pet solid waste storage apparatus wherein said apparatus is intended to provide a portable means to contain solid pet waste.

### BACKGROUND OF INVENTION

Household pets have become common in suburban and urban communities. These pets need exposure to open spaces to perform normal bodily functions, such as producing solid waste. Any deposited solid pet waste must be removed from the public areas of communities, such as sidewalks, parks and streets, and discarded with other waste. If left alone, solid pet waste can become a nuisance and even a health hazard. Animal pet waste may contain many forms of infectious disease.

In order to ensure prompt removal of any deposited pet waste, communities have placed the burden and responsibility of removing and properly disposing of this solid waste on the pet owner(s). Many local communities have passed laws requiring pet owners to promptly pick up any deposited solid waste from their pets and properly dispose of it. Failure to comply with these laws often results in hefty fines for the pet owner. In addition, most pet owners feel an obligation to clean up after their pets.

Removing deposited solid pet waste can be an unpleasant and embarrassing task for a pet owner. Solid pet waste often emits a pungent smell that may be offensive. In addition, as mentioned above, solid pet waste may contain numerous infectious diseases. A pet will often deposit solid waste in a location that is not close to a proper disposal receptacle. Thus, the pet owner may have to carry the solid pet waste an appreciable distance to properly dispose of it.

A pet owner often has to maintain their pet upon a leash at all times for practical and legal purposes. Many pets may run into dangerous situations if not properly restrained by the pet owner at all times. Thus, a pet owner must pick up any deposited waste, hold it and carry it while restraining the pet. Since most leashes require the use of at least one hand, if not two for larger pets, then the pet owner must pick up and carry the waste with only one free hand.

Furthermore, pet owners, due to their work schedules, often walk their pets outdoors during low light periods of the day, such as early morning and late evening. It may be difficult to see the deposited waste without additional light, such as a flashlight.

Previous solutions for pet solid waste removal include simple disposable plastic bags, belt pouches, leash cups, paper bags, shovels, scoops and various other ordinary items modified to perform this chore. For instance, Demeur et al., U.S. Published Patent Application No. 2002/0139803, disclose a portable container adapted for disengageable engagement with an animal pet leash. Woolley et al., U.S. Published Patent Application No. 2003/0111022, disclose a pouch attached to a leash. Baker, U.S. Published Patent Application No. 2006/0054107, also discloses a waste-carrying pouch. Galdo, U.S. Published Patent Application No. 2006/0231043, discloses a pet waste cleanup pouch having two compartments. Che, U.S. Published Patent Application No. 2007/0241123, discloses a pet waste bag dispenser having a pouch body, a pouch cover, and a bag dispenser. Sebastian, U.S. Pat. No. 5,718,192, discloses an animal waste carrying bag and leash for carrying articles such as pet waste, waste retrieval articles, bags, and personal belongings. Fingerett et al., U.S. Pat. No. 6,035,809, disclose a leash pouch for containing disposable bags and animal waste when walking animals. Beaupre, U.S. Published Patent Application No. 2006/0219188, discloses an implement for carrying waste while using a leash. Knudson, U.S. Pat. No. 5,713,616, discloses a receptacle having a chamber for receiving pet waste and holding a plurality of tools. Conboy, U.S. Pat. No. 5,727,500, discloses a leash-mounted storage device including front and rear pouches. The front pouch includes a front opening for receiving a supply of disposable bags. The rear pouch includes a top opening for receiving dirty bags after they are filled with animal waste. Carey, U.S. Pat. No. 6,019,067, discloses an article-carrying receptacle for attachment to a leash includes a body portion for holding articles. Polding, U.S. Pat. No. 6,073,590, discloses a dog leash that is equipped with a container for containing a supply of plastic grocery bags for collecting pet excrement. Miller, U.S. Pat. No. 6,085,695, discloses a pet leash bag for carrying or holding articles such as pet waste disposal bags, other pet accessories or toys and personal articles of the pet owner. Johnson, U.S. Pat. No. 6,129,096, discloses a cleanup kit including a bag and shoulder carrying strap. Ringelstetter, U.S. Pat. No. 6,199,737, discloses a pet-waste collection pouch having front, rear and side-walls defining an interior open topped chamber for holding plastic litter bags containing retrieved pet-waste. Rodriguez, U.S. Pat. No. 6,237,533, discloses an apparatus with unused bags for pet waste in one compartment and filled waste bags in another compartment. Starratt, U.S. Pat. No. 6,418,881, discloses a leash pouch for storing disposable bags and for temporarily storing animal waste. Benedettini, U.S. Pat. No. 6,588,375, discloses a retaining member connected to a leash and adapted to retain a container for collecting and disposing animal waste. Layman, U.S. Pat. No. 7,073,462, discloses an organizer with a pouch that separate compartments for a leash and other accessories.

These previous solutions lack a hands-free sanitary waste collection device that is connected to a leash and contain enough tools and accessories that a pet owner may require.

### SUMMARY OF THE INVENTION

The instant invention, as illustrated herein, is clearly not anticipated, rendered obvious, or even present in any of the prior art mechanisms, either alone or in any combination thereof. A portable waste storage device with various features for carrying waste pick-up and related tools would afford users advantages over the prior art. Thus, the several embodiments of the instant invention are illustrated herein.

Therefore, it is an object of the present invention to overcome the previously mentioned shortcomings found in the prior art by providing a waste storage apparatus that may be removably attachable to an animal restraining apparatus. It is another object of the present invention to provide a waste storage apparatus that can store accessory items. It is another object of the present invention to provide a waste storage apparatus that may store disposable waste bags. It is another object of the present invention to provide a waste storage apparatus that comprises in one embodiment a removably attached handle that can be optionally attached to a leash.

One embodiment of the subject invention provides for a solid matter storage device comprising at least one storage member chamber and at least one solid matter storage member contained within the storage member chamber, wherein the solid matter storage member further comprises at least one opening and a cavity.

In another embodiment of the subject invention, the storage member chamber comprises at least one external gripping member and a plurality of securing members, wherein the securing members attach the gripping member to an animal restraining device.

In a further embodiment of the subject invention, the external gripping member comprises at least one loop.

In an embodiment of the subject invention, the securing members attach the gripping member to an animal restraining device by passing through the loop.

In another embodiment of the subject invention, the animal restraining device is a leash.

In a further embodiment of the subject invention, the leash comprises a material selected from the group consisting of metal, leather, plastic, nylon, polyester and corded fabric.

In another embodiment of the subject invention, the leash comprises a length selected from the group consisting of a fixed length and a retractable length.

In one embodiment of the subject invention, the solid matter storage device further comprises at least one substantially tubularly shaped accessory storage member.

In another embodiment of the subject invention, the accessory storage member further comprises at least one opening so as to allow a light emitting apparatus to be removably inserted into the accessory storage member.

In a further embodiment of the subject invention, the light-emitting apparatus is a flashlight.

In one embodiment of the subject invention, the solid matter storage device further comprises at least one waste bad storage member.

In another embodiment of the subject invention, the waste bag storage member further comprises at least one opening so as to allow a waste bag to be inserted into the waste bag storage member.

In a further embodiment of the subject invention, the solid matter storage member comprises at least one lid.

In one embodiment of the subject invention, the lid is removably attached to the solid matter storage member.

In another embodiment of the subject invention, the lid is permanently attached to the solid matter storage member.

In a further embodiment of the subject invention, the lid is attached by a hinge to the solid matter storage member.

In another embodiment of the subject invention, the lid forms an air tight seal when placed over the opening of the solid matter storage member.

One embodiment of the subject invention provides for a portable animal waste storage apparatus comprising: an animal waste member storage chamber comprising at least one first opening; a first storage member comprising at least one second opening and at least one enclosing member for the second opening, wherein the first storage member is contained within the waste member storage chamber; a second storage member externally attached to the waste member storage chamber, wherein the second storage member is tubular in shape and contains at least one third opening; a third storage member externally attached to the waste member storage chamber, wherein the third storage member contains at least one fourth opening; a plurality of securing members; and at least one gripping member externally attached to the waste member storage chamber.

In another embodiment of the subject invention, the first storage member further comprises a cavity, wherein the enclosing member is hingedly attached to the first storage member, and further wherein the gripping member is removably attached.

One embodiment of the subject invention provides for a solid pet waste storage device comprising: at least one primary storage member chamber, wherein the storage member chamber further comprises a bottom portion and at least one vertical portion attached to the bottom portion to form a side portion of the storage member chamber, further wherein the vertical portion forms at least one top opening for the storage member chamber, further wherein the storage member chamber comprises a flexible, light-weight material; at least one storage member comprising a bottom portion and at least one side wall portion, wherein the storage member is removably inserted into the storage member chamber through the top opening of the storage member chamber, further whether the storage member contains a top opening that opens in the same direction as the top opening for the storage member chamber; at least one lid attached to the storage member that closes over the top opening of the storage member to form an airtight seal; a permanently or removably external gripping member attached to the side portion of the storage member chamber, wherein the gripping member contains at least one loop; a plurality of securing members; at least one animal restraining device, wherein the plurality of securing members removably attach the storage member chamber to the animal restraining device; at least one substantially tubularly shaped accessory storage member attached to the side portion of the storage member chamber, wherein the accessory storage member contains at least one opening, further wherein the accessory storage member comprises a flexible, light-weight material; at least one light emitting apparatus, wherein the light emitting apparatus is removably inserted into the accessory storage member through the opening of the accessory storage member; at least one waste bag storage member attached to the side portion of the storage member chamber, wherein the waste bag storage member contains at least one opening, further wherein the waste bag storage member comprises a flexible, light-weight material; at least one waste bag, wherein the waste bag is removably inserted into the waste bag storage member through the opening of the waste bag storage member

In another embodiment of the subject invention, the lid of the storage member may be removably attached from the storage member. In another embodiment of the subject invention, the lid of the storage member may be hingedly attached to the storage member.

In one embodiment of the subject invention, the securing members removably attach the storage member chamber to the animal restraining device by looping through at least one loop on the gripping member.

In another embodiment of the subject invention, the flexible, light-weight material is a material comprised entirely or partially of nylon or polyester.

These together with other objects of the invention, along with various features of novelty which characterize the invention, are pointed out with particularity in the claims, Detailed Description of the Embodiments Sections and drawings of this application, with all said sections adding to this disclosure.

### BRIEF DESCRIPTION OF THE DRAWINGS

FIG. 1 illustrates a side view of the solid waste storage device, wherein said device is removably attached to a leash.

FIG. 2 illustrates an opposing side view of the solid waste storage device.

FIG. 3 illustrates another side view of the solid waste storage device, wherein a gripping member is illustrated.

FIG. 4 illustrates another opposing side view of the solid waste storage device displaying a storage member lid open above said chamber.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for operating the invention in connection with the illustrated embodiments. However, it is to be understood that the same or equivalent functions and sequences may be accomplished by different embodiments that are also intended to be encompassed within the spirit and scope of the invention, such as portable waste management devices that have different shapes, dimensions and sizes.

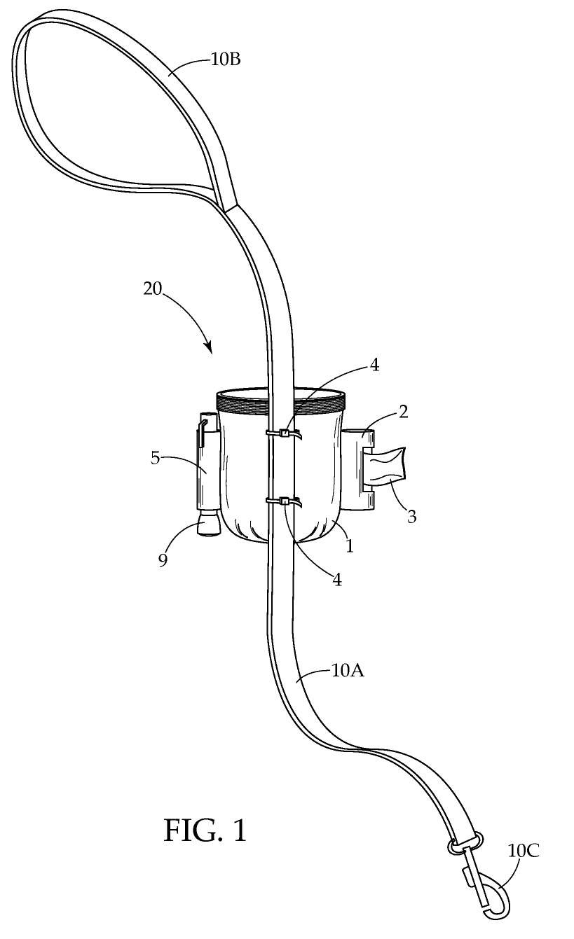

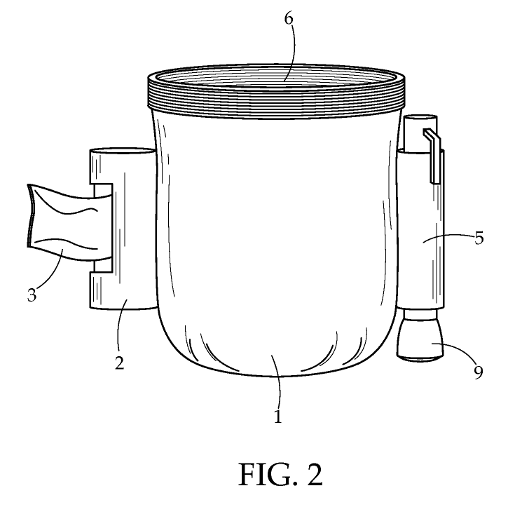

FIGS. 1-4 illustrate key features of the portable solid matter storage device 20, including a substantially centrally located storage member chamber 1. In one embodiment of the subject invention, storage member chamber 1 may have a flat bottom and a circular shape. In this embodiment, a single vertical side wall may be attached to said bottom to form a circular opening 6.

In another embodiment of the subject invention, storage member chamber 1 may have a flat bottom and a shape with four corners and four edges or substantially square in shape (not shown). In this embodiment, four vertical side walls may be attached to each edge of said bottom to form a substantially square opening 6 (not shown).

In a further embodiment of the subject invention, storage member chamber 1 may have a flat bottom and a shape with three corners and three edges or substantially triangular in shape (not shown). In this embodiment, three vertical side walls may be attached to each edge of said bottom to form a substantially triangular opening 6 (not shown).

Attached on the outside of a vertical side wall of storage member chamber 1 is a substantially cylindrical tubular accessory storage member 5 containing a top and bottom openings. The top opening of storage member 5 may be proximate to opening 6 and distal to the bottom of storage member chamber 1. The bottom opening of storage member 5 may be distal to opening 6 and proximate to the bottom of storage member chamber 1.

In one embodiment of the subject invention, accessory storage member 5 removably holds a flashlight 9. In this embodiment, accessory storage member 5 removably holds flashlight 9 so that the light beam emitted from the flashlight shines in a substantially perpendicular direction from the flat surface of the bottom of storage member chamber 1.

In another embodiment of the subject invention, storage member 5 may be a continuous portion that made of an expandable elastic material such as nylon, or a combination of fabrics containing nylon. In this embodiment, an accessory, such as a flashlight, is inserted by a user into the top or bottom opening of storage member 5, storage member 5 then expands to allow the accessory to side through and firmly holds onto the accessory.

In a further embodiment of the subject invention, storage member 5 may be two portions that contain means for connection and reconnection. In this embodiment, the two portions of storage member 5 are disconnected and an accessory, such as a flashlight, is inserted by a user into the open storage member 5. The two portions are then reconnected to firmly hold onto the accessory. Such means for connection and reconnection may include, but are not limited to, Velcro®, buttons, clasps and ties.

Also attached on the outside of a vertical side wall of storage member chamber 1, on a substantially opposing side of accessory storage member 5, is waste bag storage member 2 for holding solid waste disposable waste bags 3. In one embodiment of the subject invention, waste bag storage member 2 is a substantially six-sided box. In another embodiment of the subject invention, solid waste disposable waste bags 3 may be pulled from an opening in waste bag storage member 2.

Waste bag storage member 2 may contain a top opening that is proximate to opening 6 and distal to the bottom of storage member chamber 1. Waste bag storage member 2 may also contain an opening that allows solid waste disposable waste bags 3 to be pulled through the opening in a direction away from storage member chamber 1.

In one embodiment of the subject invention, waste bag storage member 2 may be made of an expandable elastic material such as nylon, or a combination of fabrics containing nylon. In this embodiment, solid waste disposable waste bags 3 are inserted by a user into the opening of waste bag storage member 2, waste bag storage member 2 then expands to allow multiple solid waste disposable waste bags 3 to be inserted.

In a further embodiment of the subject invention, waste bag storage member 2 may have a cover for its opening (not shown). This cover may contain means for connection and reconnection to a portion of waste bag storage member 2 or storage device 20. Such means for connection and reconnection may include, but are not limited to, Velcro®, buttons, clasps and ties.

FIG. 1 further illustrates a plurality of securing members 4, wherein said securing members 4 disengageable engage said storage device 20 to an animal control apparatus, such as a leash 10a. FIG. 1 illustrates the orientation of storage device 20 with regard to the leash handle 10b and the pet collar connector 10c. In this embodiment, opening 6 of storage member chamber 1 faces towards a user and away from the pet connected to the leash 10a. Waste bag storage member 2 and accessory storage member 5 are located on substantially opposing sides of one another. In this embodiment, accessory storage member 5 holds flashlight 9 so as to shine the light beam towards the pet and away from the user. In one embodiment of the subject invention, securing members 4 are ties. Such ties may be composed of plastic, paper, nylon, cloth or any combination thereof.

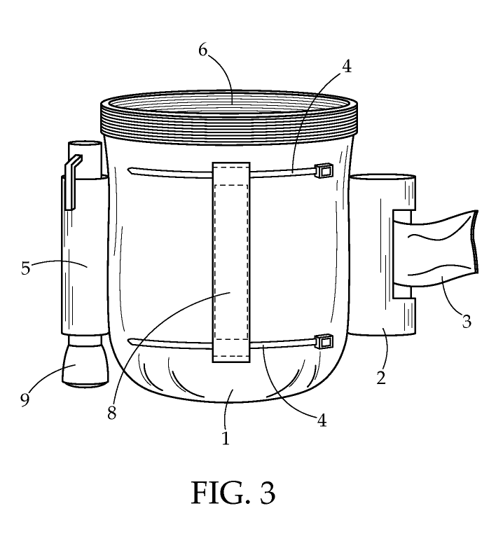

As illustrated in FIG. 3, the securing members 4 may be further secured to the storage device 20 with a gripping member 8. Gripping member 8 contains a first loop at one end and a second loop at the other end to allow securing members 4 to pass through the loops and attach the storage device 20 to the leash 10a. In one embodiment of the subject invention, securing members 4 may be made taunt to prevent storage device 20 from moving up and down the leash 10a. Securing members 4 may be loosened, but not detached, so that a user may grasp said gripping member 8 to move the portable solid matter storage device 20 up and down the leash 10a.

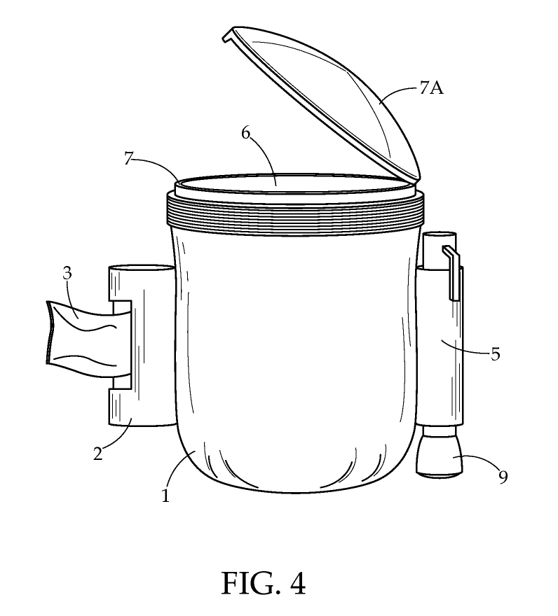

Illustrated in FIG. 4 is storage member 7. As shown in FIG. 4, animal waste storage member 7 is placed within storage member chamber 1 through opening 6. Animal waste storage member 7 contains an opening that is parallel with opening 6 once animal waste storage member 7 is placed within storage member chamber 1.

In one embodiment of the subject invention, storage member chamber 1 may be a continuous portion that made of an expandable elastic material, such as nylon, or a combination of fabrics containing nylon. In this embodiment, animal waste storage member 7 is inserted by a user into opening 6 with the opening of animal waste storage member 7 facing the user. Storage member chamber 1 expands to allow animal waste storage member 7 to side through opening 6 and firmly holds onto animal waste storage member 7.

In one embodiment of the subject invention, storage member chamber 1 may be two portions that contain means for connection and reconnection. In this embodiment, the two portions of storage member chamber 1 are disconnected and animal waste storage member 7 is inserted by a user into opening 6 with the opening of animal waste storage member 7 facing the user. The two portions are then reconnected to firmly hold onto animal waste storage member 7. Such means for connection and reconnection may include, but are not limited to, Velcro®, buttons, clasps and ties.

Animal waste storage member 7 may contain a lid 7a. In one embodiment of the subject invention, lid 7a contains a hinge connection to animal waste storage member 7. In one embodiment of the subject invention, lid 7a forms an air tight seal with animal waste storage member 7 to prevent any solid animal waste smell from escaping when closed.

In one embodiment of the subject invention, storage member 7 may be a disposable member. Such disposable members may be composed of paper, plastic, Styrofoam or any combination thereof. In another embodiment of the subject invention, storage member 7 may be composed of an easily cleaned and reusable material such a metal or plastic.

Embodiments of the subject invention may be attachable to any form of pet leash, including but not limited to metal, leather, plastic, corded, retractable length, fixed length or any combination thereof.

In one embodiment of the subject invention, prior to taking a pet outdoors, a user inserts animal waste storage member 7 into storage member chamber 1 through opening 6. The user then inserts flashlight 9 into accessory storage member 5 through the top or bottom opening. The user may then insert solid waste disposable waste bags 3 into waste bag storage member 2. The user removably attaches said storage device 20 to an animal control apparatus, such as a leash 10a, using securing members 4 so that opening 6 of storage member chamber 1, and the opening of animal waste storage member 7 faces towards the user and away from the pet connected to the leash 10a.

Once the pet deposits solid waste outdoors, the user removes a solid waste disposable waste bag 3 through the opening of waste bag storage member 2. The user picks up the solid waste and opens lid 7a on the animal waste storage member 7. The user places the solid waste and the used solid waste disposable waste bag 3 into animal waste storage member 7 and closes lid 7a. Lid 7a forms an air tight seal with animal waste storage member 7 to prevent any waste smell from escaping when closed.

Once the user has reached an acceptable disposal receptacle, the user opens lid 7a on the animal waste storage member 7 and removes the solid waste and the used solid waste disposable waste bag 3 and places them into the disposal receptacle.

What is claimed is:

1. A solid matter storage device comprising at least one storage member chamber and at least one solid matter storage member contained within the storage member chamber, wherein the solid matter storage member further comprises at least one opening and a cavity.

2. The solid matter storage device of claim 1, wherein the storage member chamber comprises at least one external gripping member and a plurality of securing members, wherein the securing members attach the gripping member to an animal restraining device.

3. The solid matter storage device of claim 2, wherein the external gripping member comprises at least one loop.

4. The solid matter storage device of claim 3, wherein the securing members attach the gripping member to an animal restraining device by passing through the loop.

5. The solid matter storage device of claim 2, wherein the animal restraining device is a leash.

6. The solid matter storage device of claim 5, wherein the leash comprises a material selected from the group consisting of metal, leather, plastic, nylon, polyester and corded fabric.

7. The solid matter storage device of claim 5, wherein the leash comprises a length selected from the group consisting of a fixed length and a retractable length.

8. The solid matter storage device of claim 1, wherein the solid matter storage device further comprises at least one substantially tubularly shaped accessory storage member.

9. The solid matter storage device of claim 8, wherein the accessory storage member further comprises at least one opening so as to allow a light emitting apparatus to be removably inserted into the accessory storage member.

10. The solid matter storage device of claim 9, wherein the light-emitting apparatus is a flashlight.

11. The solid matter storage device of claim 1, wherein the solid matter storage device further comprises at least one waste bad storage member.

12. The solid matter storage device of claim 11, wherein the waste bag storage member further comprises at least one opening so as to allow a waste bag to be inserted into the waste bag storage member.

13. The solid matter storage device of claim 1, wherein the solid matter storage member comprises at least one lid.

14. The solid matter storage device of claim 13, wherein the lid is removably attached to the solid matter storage member.

15. The solid matter storage device of claim 13, wherein the lid is permanently attached to the solid matter storage member.

16. The solid matter storage device of claim 13, wherein the lid is attached by a hinge to the solid matter storage member.

17. The solid matter storage device of claim 13, wherein the lid forms an air tight seal when placed over the opening of the solid matter storage member.

18. A portable animal waste storage apparatus comprising:
an animal waste member storage chamber comprising at least one first opening;
a first storage member comprising at least one second opening and at least one enclosing member for the second opening, wherein the first storage member is contained within the waste member storage chamber;
a second storage member externally attached to the waste member storage chamber, wherein the second storage member is tubular in shape and contains at least one third opening;
a third storage member externally attached to the waste member storage chamber, wherein the third storage member contains at least one fourth opening;
a plurality of securing members; and
at least one gripping member externally attached to the waste member storage chamber.

19. The portable animal waste storage apparatus of claim 18, wherein the first storage member further comprises a cavity, wherein the enclosing member is hingedly attached to the first storage member, and further wherein the gripping member is removably attached.
